(19) United States
(12) Patent Application Publication
(10) Pub. No.: US 2020/0353893 A1
(43) Pub. Date: Nov. 12, 2020

(54) SECURE TEMPORARY ACCESS FOR PORTIONS OF REMOTELY OPERABLE VEHICLES

(71) Applicant: Volvo Car Corporation, Goteborg (SE)

(72) Inventors: Pedro Ivo Popelier Salomao, Sunnyvale, CA (US); Kristoffer Gronowski, Monte Sereno, CA (US)

(21) Appl. No.: 16/870,616

(22) Filed: May 8, 2020

Related U.S. Application Data
(60) Provisional application No. 62/845,750, filed on May 9, 2019.

(51) Int. Cl. B60R 25/24; B60R 25/30

(52) U.S. Cl. CPC B60R 25/246; B60R 25/305

(57) ABSTRACT

In general, techniques are described by which provide secured temporary access. A control system comprising a memory and a processor may be configured to perform various aspects of the secure temporary access techniques. The memory may comprise instructions that, when executed by the at least one processor, cause the at least one processor to determine, from a device operated by the authorized operator remotely from the vehicle, that a third party is authorized to temporarily access at least a portion of the vehicle, configure, responsive to determining that the third party is authorized to temporarily access at least the portion of the vehicle, the vehicle to secure the temporary access by the third party to at least the portion of the vehicle, and provide, responsive to securing the temporary access, and to the third party, the temporary access to at least the portion of the vehicle.

### CROSS REFERENCE TO RELATED APPLICATION

This application claims the benefit of U.S. Provisional Application No. 62/845,750 filed May 9, 2019, the entire contents of which are hereby incorporated by reference.

### TECHNICAL FIELD

This disclosure relates to vehicles and, more specifically, enabling temporary access control of vehicles.

### BACKGROUND

Vehicles are increasingly featuring connectivity to public networks, such as the Internet, which has enabled vehicle manufacturers to provide a number of first party services. First party services may refer to services that the manufacturer of the vehicle provides (or contracts with an intermediary to provide on behalf, or in the name, of the manufacturer). Such first party services may permit an authorized operator (which may include the owner) of the vehicle to remotely start the vehicle, view data concerning the vehicle (e.g., mileage, oil life, status—including lock state, engine state, fuel or charge state, door and/or trunk state, warning and/or error state, etc., and other statistics), configure various operational states (e.g., activating or deactivating heated seats, heated steering wheels, heating and cooling states, radio or other infotainment states, engine control or activation states, etc.) or otherwise interact with the vehicle remotely.

Vehicle manufacturers are beginning to allow third parties to interact remotely with vehicles operated by authorized operators (which may also be referred to as “second parties”). Third parties may generally have little or nothing to do with the manufacture or operation of the vehicle, but may provide a service or product desirable by the second parties. For example, third parties may sell a product and arrange the delivery of the products to second parties, typically by arranging delivery or otherwise delivering the product to a home or business at which the second parties reside or work.

### SUMMARY

In general, techniques are described for providing secure third party access for remotely operable vehicles. Remotely operable vehicles refer to vehicles for which access or other controls may be authorized remotely, e.g., via an Internet or other network communication in which a second party authorized operator is not present and not via a standard physical key or electronic key fob (which may be in the form of a standard key fob, a smart phone, or any other device in proximity to the vehicle). Various aspects of the techniques may enable the remotely operable vehicle to secure the temporary access by the third party to at least a portion of the vehicle. For example, the remotely operable vehicle may configure one or more cameras to capture images of the third party, which may be provided to a device associated with the authorized operator second party so that the authorized operator may monitor and/or cancel the temporary access. As another example, the remotely operable vehicle and/or the device associated with the authorized operator may inspect the captured images to validate the third party (e.g., using image analysis to inspect a logo, a badge, or other identifying material).

In this respect, the techniques may enable the vehicle to secure the temporary access, and further enable the authorized second party or the vehicle to potentially prevent the temporary access in certain circumstances. As such, the techniques may improve the safety of the contents stored within the remotely operable vehicle, possibly permitting only authorized third parties access to the remotely operable vehicle. The techniques may thereby improve operation of the vehicle itself through the improved safety during the temporary access while still enabling the temporary access for delivery of products and services, return of products, sale of products, and/or general storage of items.

In one example, aspects of the techniques are directed to a method comprising: determining, by a control system configured to control one or more aspects of a vehicle associated with an authorized operator of the vehicle and from a device operated by the authorized operator remotely from the vehicle, that a third party is authorized to temporarily access at least a portion of the vehicle; configuring, by the control system and responsive to determining that the third party is authorized to temporarily access at least the portion of the vehicle, the vehicle to secure the temporary access by the third party to at least the portion of the vehicle; and providing, by the control system, responsive to securing the temporary access, and to the third party, the temporary access to at least the portion of the vehicle.

In another example, aspects of the techniques are directed to a control system configured to control one or more aspects of a vehicle associated with an authorized operator, the control system comprising: at least one processor; a memory comprising instructions that, when executed by the at least one processor, cause the at least one processor to: determine, from a device operated by the authorized operator remotely from the vehicle, that a third party is authorized to temporarily access at least a portion of the vehicle; configure, responsive to determining that the third party is authorized to temporarily access at least the portion of the vehicle, the vehicle to secure the temporary access by the third party to at least the portion of the vehicle; and provide, responsive to securing the temporary access, and to the third party, the temporary access to at least the portion of the vehicle.

In another example, aspects of the techniques are directed to a computer-readable storage medium comprising instructions that, when executed by at least one processor of a control system configured to control one or more aspects of a vehicle associated with an authorized operator, cause the at least one processor to: determine, from a device operated by the authorized operator remotely from the vehicle, that a third party is authorized to temporarily access at least a portion of the vehicle; configure, responsive to determining that the third party is authorized to temporarily access at least the portion of the vehicle, the vehicle to secure the temporary access by the third party to at least the portion of the vehicle; and provide, responsive to securing the temporary access, and to the third party, the temporary access to at least the portion of the vehicle.

In another example, aspects of the techniques are directed to a control system configured to control one or more aspects of a vehicle associated with an authorized operator, the control system comprising: means for determining, from a device operated by the authorized operator remotely from the vehicle, that a third party is authorized to temporarily access at least a portion of the vehicle; means for configuring, by the control system and responsive to determining that the third party is authorized to temporarily access at least the portion of the vehicle, the vehicle to secure the temporary access by the third party to at least the portion of the vehicle; and means for providing, by the control system, responsive to securing the temporary access, and to the third party, the temporary access to at least the portion of the vehicle.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a block diagram illustrating an example temporary access system configured to operate in accordance with one or more aspects of secure temporary access techniques described in this disclosure.

FIG. 2 is a block diagram illustrating an example device configured to perform various aspects of the secure temporary access techniques described in this disclosure.

FIGS. 3A-3C are block diagrams illustrating an example graphical user interface presented by the user interface device of the second party device shown in FIGS. 1 and 2 to facilitate manual image-based validation of the third party in accordance with various aspects of the secure temporary access techniques described in this disclosure.

FIGS. 4A and 4B are diagrams illustrating example operation of the security model shown in FIG. 2 in automatically securing the temporary access using machine learning models to validate the third party in accordance with various aspects of the secure temporary access techniques described in this disclosure.

FIGS. 5A-5D are diagrams illustrating a sequence by which the third party may temporarily access a locked trunk of a second party vehicle to deliver a package while monitored in accordance with various aspects of the secure temporary access techniques.

FIG. 6 is a flowchart illustrating example operation of a control system configured to perform various aspects of the secure temporary access techniques described in this disclosure.

### DETAILED DESCRIPTION

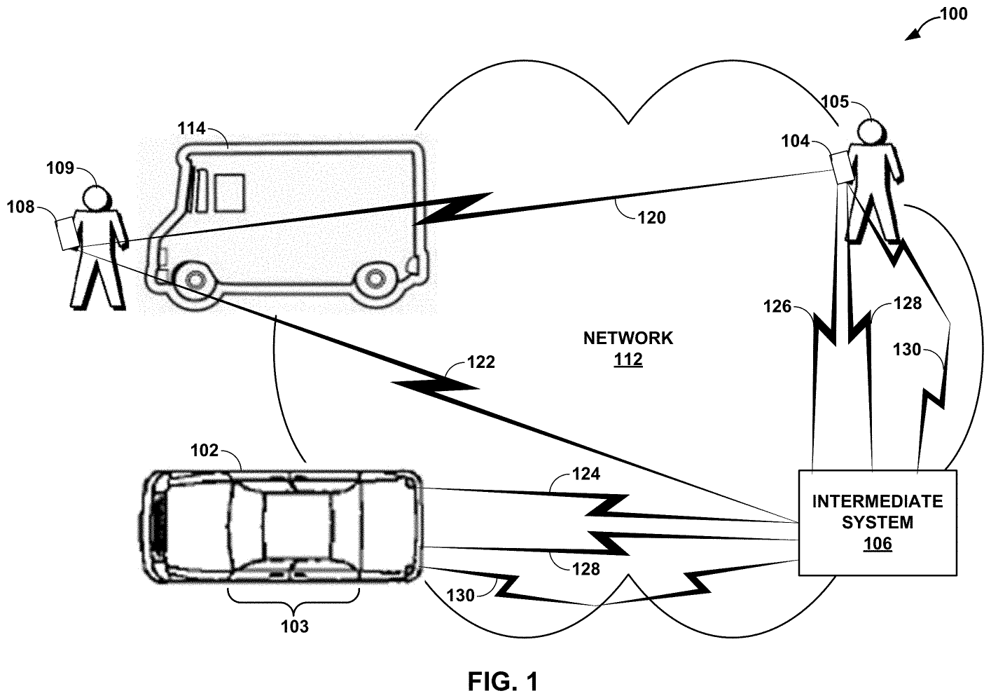

FIG. 1 is a block diagram illustrating an example temporary access system configured to operate in accordance with one or more aspects of the secure temporary access techniques described in this disclosure. As shown in the example of FIG. 1, temporary access system 100 includes a remotely operable vehicle 102, a second party device 104, an intermediate system 106, and a third party device 108.

Remotely operable vehicle 102 may represent any type of vehicle by which an authorized second party of remotely operable vehicle 102, such as second party 105, may grant, to a third party (such as third party 109), access to some locked or otherwise secured portion (which may include the entirety) of remotely operable vehicle 102. Although shown as an automobile in the example of FIG. 1, remotely operable vehicle 102 may represent any type of vehicle, including an automobile, a truck, farm equipment, a motorcycle, a bike (including electronic bikes), a scooter, construction equipment, a semi-truck, an airplane, a helicopter, a military vehicle, robot, or any other type of vehicle having a locked or secured portion to which temporary access may be granted to third party 109. The locked or secured portion of remotely operable vehicle 102 shown in the example of FIG. 1 (meaning an automobile) may include a trunk, an engine hood, a fuel lid, a glove box, an interior, or any other type of enclosed space that is capable of being locked or otherwise secured (e.g., protected by an alarm whether locked or unlocked, monitored, etc.) in an automobile.

Second party device 104 may represent any type of device capable of interacting with intermediate system 106 to remotely grant, to third party 109, access to remotely operable vehicle 102. Second party device 104 may interact with intermediate system 106 via a wired or wireless connection, and possibly via a network 112 as shown in the example of FIG. 1. Second party device 104 may execute an application or other instructions (including a software application (“app”) in examples where second party device 104 represents a smartphone) that cause one or more processors to perform various operations attributed to second party device 104 throughout this disclosure.

Examples of second party device 104 include a computer, a laptop computer, a tablet computer, a tablet, a cellular phone (including a so-called smartphone), a gaming device, a portable gaming device, an entertainment device, a portable entertainment device, a dedicated fixed function device for temporary access, a scanning device (such as a scanning device used when delivering packages or providing services), or any other type of device or combination of devices capable of remotely granting access to remotely operable vehicle 102.

Granting temporary access may refer to a process by which second party 105 authorizes or otherwise grants access to remotely operable vehicle 102 without being physically present and without providing some key, key fob, or other dedicated locking and/or unlocking device by which third party 109 may access remotely operable vehicle 102. Second party 105 may interface with second party device 104 to grant, e.g., via network 112, without being physically present or in proximity (e.g., within several 10s of feet) at remotely operable vehicle 102. Second party 105 may schedule the temporary access for a set time and duration or cause the temporary access to be granted upon identifying certain conditions. Second party device 104 may communicate via network 112 directly with vehicle 102, or indirectly via intermediate system 106 and/or third party device 108 to grant the temporary access. While described as not being physically present, second party 105 may grant temporary access while being physically present or in proximity to remotely operable vehicle 102.

Intermediate system 106 may represent a system configured to mediate between second party device 104, third party device 108, and remotely operable vehicle 102. Intermediate system 106 may authenticate users, such as second party 105 and third party 109, establish communication sessions, and issue commands that enable the temporary access and/or remote configuration of remotely operable vehicle 102. In the example of FIG. 1, intermediate system 106 interfaces with second party device 104, third party device 108, and remotely operable vehicle 102 via network 112. Network 112 may represent any type of network by which the above described operations performed by intermediate system 106 may be accomplished. Network 112 may represent a public network (e.g., the Internet), a private network, a cellular network, a personal area network, or combinations thereof.

Third party device 108 may be similar to second party device 104. Third party device 108 may, in other words, represent any type of device capable of interacting with intermediate system 106 to remotely gain access to remotely operable vehicle 102. Third party device 108 may interact with intermediate system 106 via a wired or wireless connection, and possibly via a network 112 as shown in the example of FIG. 1. Third party device 108 may execute an application or other instructions (including an “app” in examples where second party device 104 represents a smartphone or tablet or other app-driven device) that cause one or more processors to perform various operations attributed to third party device 108 throughout this disclosure.

Using the above described network connectivity, vehicle manufacturers are beginning to introduce intermediate systems 106 that allow third party 109 to interact remotely with vehicle 102 operated by authorized operator 105, where the so-called “first party” is the vehicle manufacturer. Third party 109 may generally have little or nothing to do with the vehicle manufacturer or operation of vehicle 102, but may provide a service or product desirable by second party 105. For example, third party 109 may sell a product and arrange the delivery of the products to second party 105, typically by arranging delivery or otherwise delivering the product to a home or business at which second party 105 reside or work or positioned. Vehicle manufacturers may enable second party 105 to remotely grant access to remotely operable vehicle 102 by third party 109 in order to deliver products to remotely operable vehicle 102, or at least a portion of the remotely operable vehicle, or perform services with respect to remotely operable vehicle 102, or at least a portion of the remotely operable vehicle.

In some examples, remotely operable vehicle 102 comprises a remotely operable lock that controls access to a locked space 103, such as an interior space, of remotely operable vehicle 102. Although shown as the interior space, the locked space 103 may be represented by one or a combination of the body, a trunk, an engine hood, a fuel lid and/or an isolated section of remotely operable vehicle 102. The remotely operable lock in the example of the interior space may refer to one, or several, of the door locks of remotely operable vehicle 102.

Remotely operable vehicle 102 is configured to enable a temporary user, such as third party 109, to gain temporary access to locked space 103. Third party 109 may represent any temporary user to whom may be given access to locked space 103 during a restricted period of time. Remotely operable vehicle 103 is further configured to communicate with an intermediate system 106, where intermediate system 106 may be configured, in some examples, to operate as a control system configured to remotely control functionality of remotely operable vehicle 102. Intermediate system 102 may represent an adapted management and/or assisting system, such as e.g., Volvo On Call.

Furthermore, intermediate system 106 is configured to directly or indirectly communicate with second party device 104 associated with second party 105 of remotely operable vehicle 102. Second party device 104 is configured to transmit a permission message 120 comprising access parameters directly or indirectly to third party device 108. Permission message 120 may comprise at least one short message service (SMS) message, at least one email and/or a corresponding type of message. A corresponding type of message may for instance be a message of a generic format, or a message of a customized format according to which third party device 108 may communicate with second party device 104. The access parameters of the illustrated example comprise one or several of vehicle identification parameters, time frame parameters, location parameters, and/or recurrence parameters.

Third party device 108 is configured to transmit a request message 122 to open the lock of remotely operable vehicle 102, to remote intermediate system 106, where request message 122 includes the access parameters. Correspondingly, intermediate system 106 is configured to receive request message 122. Request message 122 may be comprised in at least one SMS message, at least one email and/or a corresponding type of message, such as for instance a message of a generic format or a message of a customized format according to which third party device 108 may communicate with intermediate system 106.

In the example of FIG. 1, the permission message 124 is assumed to represent a user selectable web link connecting to remote intermediate system 106, where the web link is adapted to, upon being selected, initiate transmission of request message 122 to intermediate system 106. Furthermore, in this instance, vehicle 102 is configured to receive, from intermediate system 106, based on request message 122, an unlock message 124 to open lock controlling access to locked space 103, whereby the lock may unlock based on the access parameters. Correspondingly, intermediate system 106 is configured to, based on request message 122, transmit unlock message 124 to remotely operable vehicle 102 to open the lock controlling access to locked space 103. Unlock message 124 may comprise at least one SMS message, at least one email and/or a corresponding type of message, such as for instance a message of a generic format or a message of a customized format according to which intermediate system 106 may communicate with remotely operable vehicle 102.

In some examples, the temporary access messages 120-124 may include an additional optional verification message provided by second party device 104 to intermediate system 106. That is, second party device 104 is configured to transmit a verification message 126 to intermediate system 106, where verification message 126 includes verification parameters corresponding to the access parameters. When the verification parameters correspond to the access parameters, intermediate system 106 may transmit unlock message 124 to enable the lock to be unlocked. Correspondingly, intermediate system 106 is configured to receive verification message 106 from owner device 104.

Verification message 126 may include, for example, a SMS message, at least one email and/or a corresponding type of message, such as for instance a message of a generic format or a message of a customized format according to which second party device 104 may communicate with intermediate system 106. Furthermore, the verification parameters may, in a similar manner to the access parameters, comprise one or several of vehicle identification parameters, time frame parameters, location parameters, and/or recurrence parameters. Furthermore, the verification parameters may comprise a subset of the access parameters, and/or further parameters applicable to indicate the framing of the intended, subsequent, temporary access provision.

In these and other examples, rather than send permission message 120 from owner device 21 to the user device 31, second party device 104 may send permission message 120 to intermediate system 106. Intermediate system 106 may then transmit permission message 120 to third party device 108. Regardless of how temporary access messages 120-126 are sent, remotely operable vehicle 102 may enable third party 109 to access a previously locked space 103 of remotely operable vehicle 102 to deliver packages and/or perform services (e.g., repairs).

Although granting access to third parties may provide convenience to remote second parties, second parties may hesitate to adopt such temporary access practices as there are various concerns with security and other aspects of granting access when the second parties are remote and unable to oversee the third parties. For example, an unauthorized third party may be present when temporary access to locked space 103 is granted, and third party 109 may not notice that the unauthorized third party accesses the locked space 103 during the time frame during which the temporary access is granted. The unauthorized third party may damage vehicle 102, remove items from locked space 103, etc.

In accordance with various aspects of the techniques described in this disclosure, remotely operable vehicle 102 may include a control system configured to provide secure third party access. For example, the control system may configure one or more cameras to capture images of third party 109, which may be provided to second party device 104 associated with second party 105 so that second party 105 may monitor and/or cancel the temporary access. As another example, the control system and/or second party device 104 may inspect the captured images to validate third party 109 (e.g., using image analysis to inspect a logo, a badge, or other identifying material).

In this respect, the techniques may enable a control system configured to control one or more aspects of remotely operable vehicle 102 to secure the temporary access, and further enable second party 105, the control system for vehicle 102 and/or second party device 104 to potentially prevent or revoke the temporary access in certain circumstances. As such, the techniques may improve the safety of the contents stored within remotely operable vehicle 102, possibly permitting only authorized third parties 109 access to remotely operable vehicle 102. The techniques may thereby improve operation of vehicle 102 itself through the improved safety during the temporary access while still enabling the temporary access for delivery of products and services, return of products, sale of products, and/or general storage of items.

In operation, the control system may be configured to control one or more aspects of remotely operable vehicle 102, such as the lock to locked space 103, the above referenced cameras, hood latches, fuel cover latches, trunk latches, etc. The control system may be local to remotely operable vehicle 102, e.g., a component integrated into remotely operable vehicle 102. In some examples, intermediate system 106 may represent the control system, which interacts with an interface presented by remotely operable vehicle 102 to control the various aspects of remotely operable vehicle 102 discussed above. In other examples, the control system is a combination of remotely operable vehicle 102 and intermediate system 106.

In any event, the control system may receive authorization (e.g., in the form of one or more of temporary access messages 120-126) to permit access by a third party 109 to locked space 103 of remotely operable vehicle 102. That is, when the control system is integrated within remotely operable vehicle 102, the control system may obtain authorization to permit the temporary access in the form of unlock message 124. When the control system is represented by intermediate system 106, intermediate system 106 may receive authorization upon receiving request message 122 from third party device 108. In this respect, the control system may determine that third party 109 is authorized to temporarily access at least a portion (i.e., locked space 103 in the example of FIG. 1) of vehicle 102.

The control system may configure, responsive to receiving the authorization to permit the access to locked space 103, vehicle 102 to secure the temporary access by third party 109 to locked space 103. The control system may configure vehicle 102 to provide additional security in a number of different ways, some of which were briefly discussed above.

As noted above, the control system may activate one or more cameras associated with vehicle 102. The one or more cameras may be integrated within vehicle 102, such as a cabin or interior camera, a backup camera, cameras utilized for self-driving or autonomous driving functions, driver cameras utilized to capture a state of awareness of the driver or other occupants, etc. In these and other examples, the cameras may be coupled to vehicle 102, such as dashboard cameras registered with intermediate system 106 and coupled to vehicle 102 via a universal system bus (USB) or wirelessly, or other add-on or later-installed cameras that are registered with intermediate system 106 and coupled to vehicle 102 via USB or wirelessly.

The cameras may capture one or more images (which may, in some examples, form video or otherwise represent video) concurrent to the temporary access of locked space 103 by third party 109. The control system may receive these images from the cameras. The control system may, in some examples, provide the images to second party device 104 for, as described in more detail below, manual and/or semi-manual validation of third party 109. Manual validation may refer to validation performed manually by second party 105. Semi-manual validation may refer to validation performed manually by second party 105 but assisted using automated process that facilitate manual validation of third party 109.

In manual or semi-manual validation, second party 105 may interface with second party device 104 to cause second party device 104 to transmit either a deny message 128 or a validation message 130. Second party device 104 may, responsive to receiving input indicating that third party 109 has not been validated, generate denial message 128, which may be similar in format to any of temporary access messages 120-126, but specify that the temporary access is to be denied or otherwise cancelled or revoked. Second party device 104 may transmit denial message 128 to intermediate system 106. Intermediate system 106 may forward denial message 128 to vehicle 102 when the control system is integrated into vehicle 102, whereupon the control system cancels or revokes the temporary access thereby denying third party 109 access to locked space 103. When intermediate system 106 operates as the control system, intermediate system 106 may, responsive to denial message 128, issue one or more commands to reengage one or more locks securing locked space 103.

Second party device 104 may, responsive to receiving input indicating that third party 109 has been validated, generate validation message 130, which may be similar in format to any of temporary access messages 120-128, but specify that the temporary access is provided. Intermediate system 106 may, when the control system is integrated into vehicle 102, forward validation message 130 to vehicle 102, which may continue to permit the temporary access to locked space 103 by third party 109. When intermediate system 106 operates as the control system, intermediate system 106 may, responsive to validation message 130, refrain from issuing one or more commands to reengage one or more locks securing locked space 103.

Alternatively or in conjunction with the foregoing manual validation, the control system may perform some form of image analysis, such as two-dimensional and/or three-dimensional object recognition, motion detection, video tracking, image segmentation or any other form of image analysis, with respect to the one or more images to automatically (meaning without input from second party 105) validate third party 109, as described in further detail below. Briefly, the control system may apply one or more trained models to the images to identify logos or other notable aspects associated with third party 109 (including facial features or other distinguishing aspects of third party 109). The trained model may have been trained using machine learning using a series of training images including images of the logos associated with third party 109, facial features of third party 109, etc. The control system may then automatically validate third party 109, and operate as described above in terms of denying access or permitting the access to proceed, potentially removing interactions by second party 105 in manually validating third party 109.

When performing automated validation using trained models in conjunction with manual validation, second party device 104 may present a registered representation associated with the third party (such as a logo, a bar code, text, image, graphic or any other representation associated with the third party) and one or more representations identified by the trained model as being present in the images captured by the cameras, thereby facilitating manual validation using automated representation detection. Similarly, second party device 104 may present a registered facial image of the face of third party 109 and one or more faces identified by the trained model as being present in the images captured by the cameras, thereby facilitating manual validation using automated facial detection. Third party 109 may register the logo and/or facial image with intermediate system 106, where second party device 104 may interface with intermediate system 106 to retrieve the registered logo and the registered facial image.

The control system may secure the temporary access in other ways as well, either as an alternative to the camera based aspects described above or in conjunction with those aspects. The control system may, for example, determine a location of vehicle 102 and compare the location of vehicle 102 to a location of third party device 108 and/or third party vehicle 114. Based on the comparison of the locations, the control system may validate third party 109, and either deny or permit the temporary access to locked space 103 by third party 109. The control system may also, as another example, secure the temporary access by enabling second party 105 to deny the temporary access up until the locks are unlocked to locked space 103. Further, the control system may also secure the temporary access by enabling second party 105 to specify or otherwise designate which of locked spaces 103 are to be unlocked, limiting access to those of the locked spaces 103 that were designated, while refraining from unlocking locked spaces 103 that are not designated.

Assuming that the control system secures the temporary access, the control system may provide, responsive to securing the temporary access, and to third party 109, the temporary access to locked space 103. That is, the control system may, responsive to securing the temporary access, interface with vehicle 102 in the manner described above to unlock locked space 103. The control system may continue to interface with the one or more cameras to capture images during the temporary access, providing the images to second party device 104 and/or intermediate system 106. The control system may record or otherwise store the images for later viewing of the temporary access or to facilitate collection of evidence should unauthorized access, damage or other harmful events occur during the temporary access.

In this way, the techniques may enable a control system configured to control one or more aspects of remotely operable vehicle 102 to secure the temporary access, and further enable second party 105, the control system for vehicle 102 and/or second party device 104 to potentially prevent the temporary access in certain circumstances. As such, the techniques may improve the safety of the contents stored within remotely operable vehicle 102, possibly permitting only authorized third parties 109 access to remotely operable vehicle 102.

Although described with respect to a first party, a second party, and a third party, such designations should not be understood to limit various aspects of the secure temporary access techniques described herein. In some instances, for example, the first party may be authorized by the second party to temporarily access vehicle 102 (to perform services related to a warranty or recall, to provide services such as fuelling or washing of the vehicle, as a couple of examples), and various aspects of the techniques may enable a second party to secure the temporary access. As another example, a first representative of the first party may authorize temporary access by a second different representative of the first party to temporarily access vehicle 102. As such, the foregoing discussions represents one example of securing temporary access to vehicle 102 and should not be understood to limit various aspects of the secure temporary access techniques described herein.

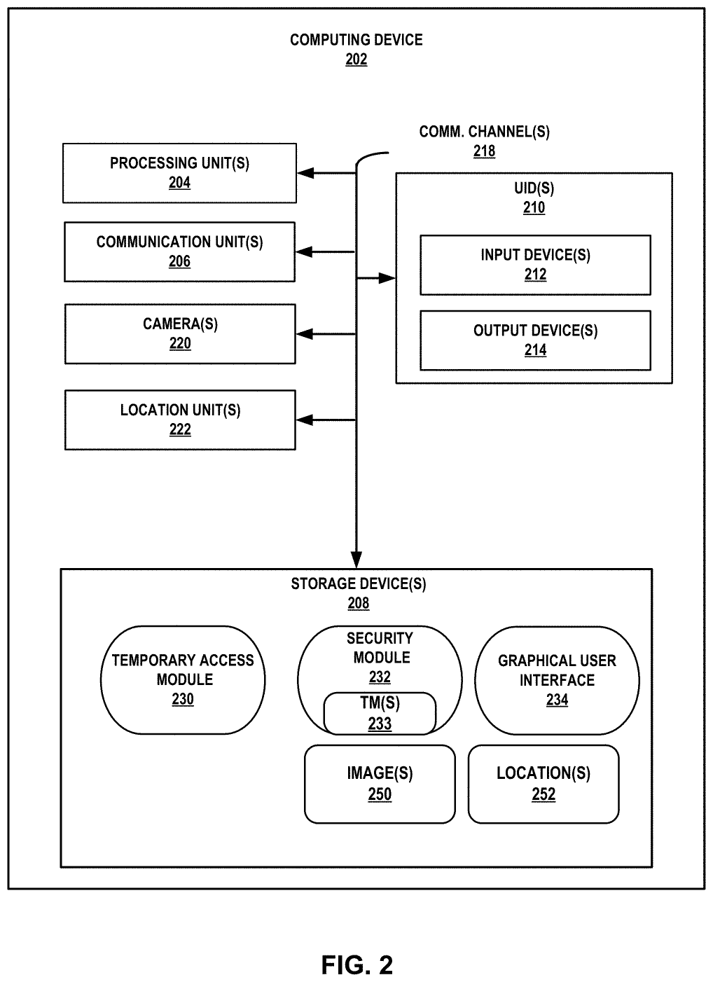

FIG. 2 is a block diagram illustrating an example device configured to perform various aspects of the secure temporary access techniques described in this disclosure. Computing device 202 represents an example of the control system described above and, where indicated, second party device 104, and third party device 108. As illustrated in FIG. 2, computing device 202 includes at least one processing unit 204, at least one communication unit 206, at least one storage device 208, at least one user interface device (UID) 210, at least one communication channel 218, at least one camera 220, and at least one location unit 222. FIG. 2 illustrates only one particular example of computing device 202, and many other examples of computing device 202 may be used in other instances and may include a subset of the components included in example computing device 202 or may include additional components not shown in FIG. 2.

Processing units 204 may represent a unit implemented as fixed-function processing circuits, programmable processing circuits, or a combination thereof. Fixed-function circuits refer to circuits that provide particular functionality and are pre-set on the operations that can be performed. Programmable circuits refer to circuits that can programmed to perform various tasks and provide flexible functionality in the operations that can be performed. For instance, programmable circuits may execute software or firmware that cause the programmable circuits to operate in the manner defined by instructions of the software or firmware. Fixed-function circuits may execute software instructions (e.g., to receive parameters or output parameters), but the types of operations that the fixed-function processing circuits perform are generally immutable. In some examples, the one or more of the units may be distinct circuit blocks (fixed-function or programmable), and in some examples, the one or more units may be integrated circuits.

Communication units 206 may represent a unit configured to communicate with one or more other computing devices by transmitting and/or receiving data. Communications units 206 may include wired and/or wireless communication units. Examples of wired communication units 206 include Universal Serial Bus (USB) transceivers. Examples of wireless communication units 206 include GPS radios, cellular (e.g., LTE) radios, Bluetooth™ radios, WiFi™ radios, or any other wireless radios.

In some examples, storage device 208 may represent a unit configured to store modules 230 and 232. Storage device 208 may be a temporary memory, meaning that a primary purpose of storage device 208 is not long-term storage. Storage device 208 may be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art.

Storage device 208 may include one or more non-transitory computer-readable storage devices. Storage device 208 may be configured to store larger amounts of information than typically stored by volatile memory. Storage device 208 may further be configured for long-term storage of information as non-volatile memory space and retain information after power on/off cycles. Examples of non-volatile memories include magnetic hard discs, optical discs, flash memories, or forms of electrically programmable memories (EPROM) or electrically erasable and programmable (EEPROM) memories. Storage device 208 may store program instructions and/or information (e.g., data) that, when executed, cause processing unit 204 to perform the techniques of this disclosure. For example, storage device 208 may include data or information associated with one or more modules 230 and 232.

User interface devices (UID) 210 may represent a unit configured to enable a user to interact with computing device 202. UIDs 210 may include one or more input devices 212 and/or more output devices 214. Examples of input devices 212 include display devices, keyboards, pointing devices (such as a mouse or digital pen), microphones, physical buttons or knobs, among others. Examples of output devices 214 include display devices and speakers, among others. Display devices may include touchscreens (e.g., capacitive or resistive). Example display devices include liquid crystal displays (LCD), light emitting diode (LED) displays, organic light-emitting diode (OLED) displays, e-ink, or other device configured to display information to a user.

Communication channels 218 may represent a unit configured to interconnect each of components 204, 206, 208, 210, 220, and/or 222 for inter-component communications (physically, communicatively, and/or operatively). In some examples, communication channels 218 may include a system bus, a network connection, one or more inter-process communication data structures, or any other components for communicating data.

Camera 220 represents a unit configured to capture one or more images of a scene. Camera 220 may include any type of unit configured to capture images, including an infrared camera, a color camera, a monochrome camera, or any other type of camera. Camera 220 may include a lens, an array of pixel sensors, and other components arranged in a manner that facilitate digital capture of images. Although shown as included within computing device 202, one or more of cameras 220 may be external from computing device 202 but communicatively coupled, via either wired or wireless connection, to computing device 202. Camera 220 may be integrated within vehicle 102 (e.g., meaning built into various aspects of vehicle 102, including interior or exterior panels, review mirrors, side mirrors, trunks, glove boxes, engine bays, etc.) or external to vehicle 102 (e.g., meaning after-market cameras added after manufacture and not integrated into various aspects of vehicle 102, including dashboard cameras, add-on backup cameras, etc.).

Location unit 222 may represent a unit configured to obtain a location of computing device 202. In examples where intermediate system 106 represents the control unit, computing device 202 may not include location unit 222 and may otherwise obtain a location of vehicle 102, second party device 104, and/or third party device 108 from a location unit positioned proximate to or within vehicle 102, second party device 104, and third party device 108. Location unit 222 may represent, as an example, one or more of a global positioning system (GPS), a global navigation satellite system (GNSS) (which may be referred to as “Galileo”), and the like configured to obtain a location of location unit 222 as one or more GPS and/or GNSS coordinates.

As further shown in the example of FIG. 2, storage device 208 stores a temporary access module 230 and a security module 232. Processing units 204 may interface with storage device 208 to retrieve one or more instructions of temporary access module 230 that, when executed, cause processing units 204 to perform operations directed to enabling the temporary access of vehicle 102 discussed above. Similarly, processing units 204 may interface with storage device 208 to retrieve one or more instructions of security module 232 that, when executed, cause processing units 204 to perform operations directed to configuring vehicle 102 to secure the temporary access of vehicle 102, as discussed above. Reference to modules 230 and 232 performing various operations should be understood to refer to processing units 204 performing the various operations discussed with respect to each of modules 230 and 232.

In any event, temporary access module 230 may determine that third party 109 is authorized to temporarily access locked space 103, and either provide the temporary access to locked space 103 or denying the temporary access to locked space 103. Temporary access module 230 may generate or receive (depending on the perspective) one or more of temporary access messages 120-130. Temporary access module 230 may interface with communication unit 206 to send and/or receive temporary access messages 120-130. Temporary access module 230 may interface with various components of vehicle 102 via communication channel 218 (when integrated within vehicle 102) and/or communication unit 206 (when integrated within and/or located externally as intermediate system 106) to issue one or more commands to lock and unlock locked space 103.

Security module 232 may represent a module configured to provide secure temporary access to locked space 103 by third party 109 in accordance with various aspects of the secure temporary access techniques described in this disclosure. Security module 232 may interface with location unit 222 via communication channel 218 to obtain one or more locations 252, which may include GPS coordinates identifying a location of location unit 222. When computing device 202 represents the control system, security module 232 may also interface with communication unit 206 to receive additional locations 252 identifying a location of location units 252 of second party device 104 and/or third party device 108. Likewise, when computing device 202 represents second party device 104, security module 232 may represent a unit configured to interface with location unit 222 to transmit a location 252 of second party device 104 to the control system via communication unit 206.

In addition, when computing device 202 represents third party device 108, security module 232 may represent a unit configured to interface with location unit 222 to transmit a location 252 of third party device 108 to the control system via communication unit 206. Moreover, when the control system is represented by intermediate system 106, vehicle 102 may include a location unit 222 that interfaces with a communication unit 206 to provide a location associated with vehicle 102 to intermediate system 106.

Regardless of how locations 252 are obtained, security module 232 may compare locations 252 associated with vehicle 102 to locations 252 associated with third party device 108. In some instances, security module 232 may calculate a relative distance between locations 252 associated with vehicle 102 and locations 252 associated with third party device 108. When the relative distance is below a threshold distance, security module 232 may validate third party 109 and permit access to locked space 103. When the relative distance is above a threshold distance, security module 232 may deny third party 109 access to locked space 103.

Security module 232 may also interface with cameras 220 via communication channels 218 to activate or otherwise enable cameras 220 to capture one or more images 250 (which may form a video) concurrent to the temporary access to locked space 103 by third party 109. While described as images 250, images 250 may form or be included within a video, and various aspects of the techniques should not be limited strictly to images 250 but may include video or some portion of a video (e.g., a graphical interchange format—GIF—video, a video clip, and/or edited video data).

As such, one or more cameras 220 may capture one or more images 250 (which, in some instances, may form a video) of third party 109 and/or third party vehicle 114 operated by third party 109. When integrated into vehicle 102, security module 232 may interface with communication unit 206 to provide the images (and possibly video) to intermediate system 106, which may forward the images 250 (and possibly video, e.g., depending on available bandwidth of the connections) to second party device 104. When integrated into intermediate system 106, security module 232 may interface with communication unit 206 to provide images 250 to second party device 105. Second party 105 may view the images via a graphical user interface 234 and validate third party 109 prior to allowing the access to locked space 103 by third party 109.

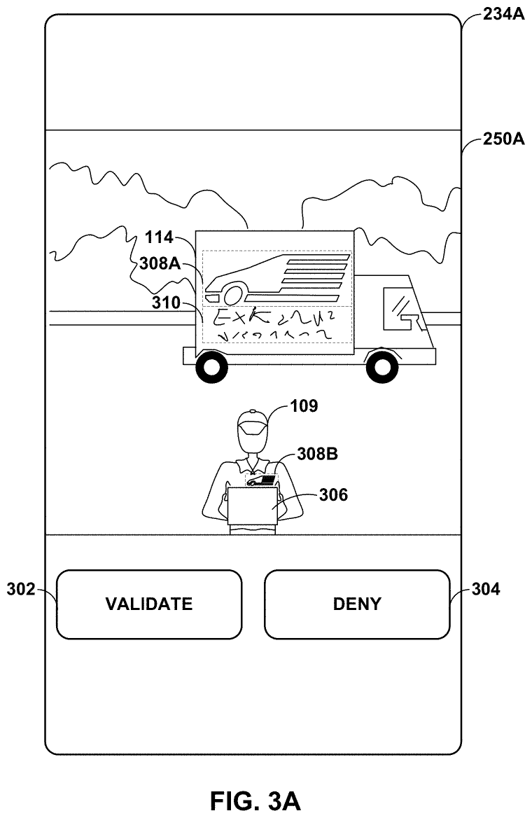

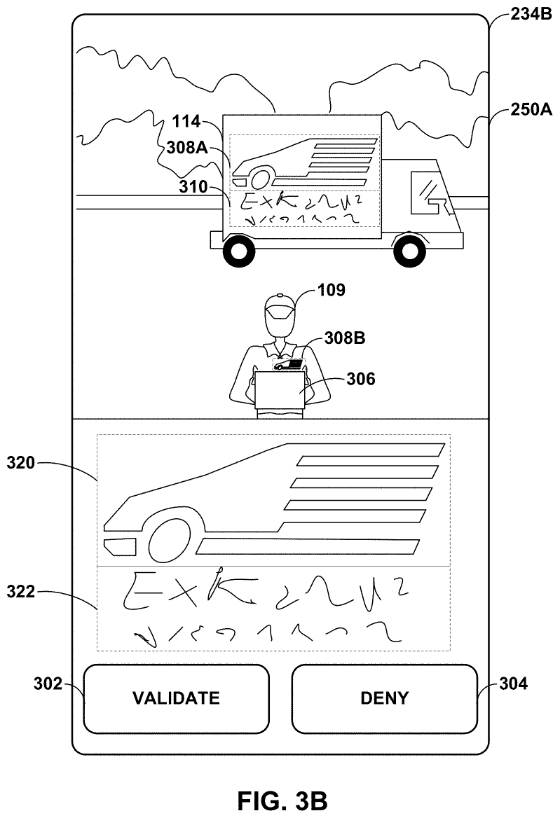

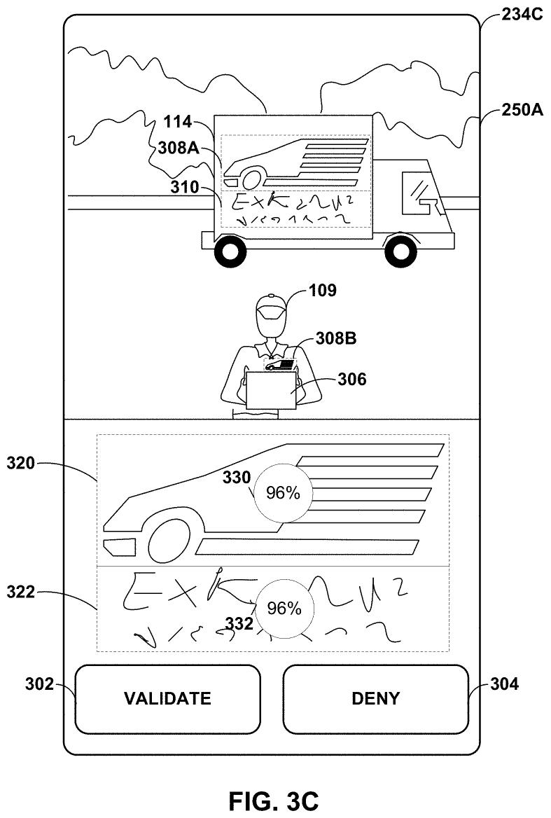

Graphical user interface 234 may represent any graphical user interface by which to display images 250 to second party 105, and may include any virtual controls (e.g., one or more of virtual buttons, virtual keys, virtual control boxes, virtual selection boxes, virtual control windows, etc.) by which to validate third party 109. More information regarding an example of graphical user interface 234 presented to second party 105 to facilitate manual image-based validation of third party 109 is described with respect to FIGS. 3A-3C.

FIGS. 3A-3C are block diagrams illustrating an example graphical user interface presented by the user interface device of the second party device shown in FIGS. 1 and 2 to facilitate manual image-based validation of the third party in accordance with various aspects of the secure temporary access techniques described in this disclosure. In the example of FIG. 3A, a graphical user interface 234A represents one example of graphical user interface 234 shown in the example of FIG. 2. Security module 232 may interface with output device 214 of user interface device 210 to present graphical user interface 234A.

As shown in the example of FIG. 3A, graphical user interface 324A includes an image 250A, and virtual buttons 302 and 304. Image 250A represents one example of images 250 shown in the example of FIG. 2. Image 250A depicts a scene with third party 109 carrying a package 306 with delivery vehicle 114 in the background. Delivery vehicle 114 includes a logo 308A associated with third party 109, and a name 310 associated with third party 109. Likewise, third party 109 is wearing a garment that also includes a logo 308B.

Virtual button 302 may represent a virtual control with which second party 105 may interact (e.g., by selecting a portion of a presence sensitive display at which virtual button 302 is displayed) to validate third party 109. Responsive to detection that second party 105 has selected virtual button 302, security module 232 may generate validation message 130 and interface with communication unit 206 to transmit validation message 130 to vehicle 102 (either directly or via intermediate system 106).

Virtual button 304 may represent a virtual control with which second party 105 may interact (e.g., by selecting a portion of a presence sensitive display at which virtual button 302 is displayed) to deny third party 109 access to locked space 103 of vehicle 102. Responsive to detection that second party 105 has selected virtual button 304, security module 232 may generate denial message 128 and interface with communication unit 206 to transmit denial message 128 to vehicle 102 (either directly or via intermediate system 106).

In order to validate third party 109, second party 105 may view image 250A and identify whether logos 308A and 308B and name 310 are the same or similar to logos and/or names previously identified as being responsible for delivery of package 306. Second party device 104 may receive, via communication unit 206, one or more electronic messages (e.g., text messages, email messages, etc.) identifying third party 109. Second party 105 may then validate, based on the electronic messages identifying third party 109 and logos 308A and/or 308B and name 310, third party 109, selecting either virtual button 302 or 304 to validate or deny the access to locked space 103 of vehicle 102.

In the example of FIG. 3B, security module 232 may obtain a graphical user interface 234B, which may represent one example of graphical user interface 234 shown in the example of FIG. 2. Security module 232 may interface with output device 214 of user interface device 210 to present graphical user interface 234B. Graphical user interface 234B is similar to graphical user interface 234A, except that graphical user interface 234B includes a reference logo 320 and a reference name 322, each of which are examples of reference images.

Reference logo 320 represents an image of logos 308A and/or 308B that third party 109 registered with intermediate system 106. Reference name 322 represents an image or text specifying a name associated with third party 109 that third party 109 registered with intermediate system 106. Second party 105 may compare reference logo 320 to logos 308A and/or 308B to validate third party 109. In addition or as an alternative to using reference logo 320, second party 105 may compare reference name 322 to name 310 in order to validate third party 109. Second party 105 may select one of virtual buttons 302 or 304 to validate third party 109 or deny access to locked space 103 of vehicle 102 respectively.

In the example of FIG. 3C, security module 232 may obtain a graphical user interface 234C, which may represent one example of graphical user interface 234 shown in the example of FIG. 2. Security module 232 may interface with output device 214 of user interface device 210 to present graphical user interface 234C. Graphical user interface 234C is similar to graphical user interface 234B, except that graphical user interface 234B includes confidence scores 330 and 332.

Confidence scores 330 and 332 represent a result of image analysis as applied to image 250A. That is, as shown in the example of FIG. 2, security module 232 may include trained models 233 that have been trained to identify one or more of registered logos 320 and/or name 322. Security module 232 may invoke trained model 233, passing image 250A to trained models 233 associated with third party 109. Trained models 233 may perform an image analysis with respect to image 250A, identifying logos 308A and 308B and name 310, calculating confidence scores 330 and 332. Graphical user interface 324C may present confidence scores 330 and 332 in order to facilitate manual validation of third party 109, where a higher percentage for each of confidence scores 330 and 332 indicates a likelihood that reference logo 320 and reference name 322 match logos 308A and/or 308B and name 310 respectively and a lower percentage for each of confidence scores 330 and 332 indicates a likelihood that reference logo 320 and reference name 322 do not match logos 308A and/or 308B and name 310 respectively.

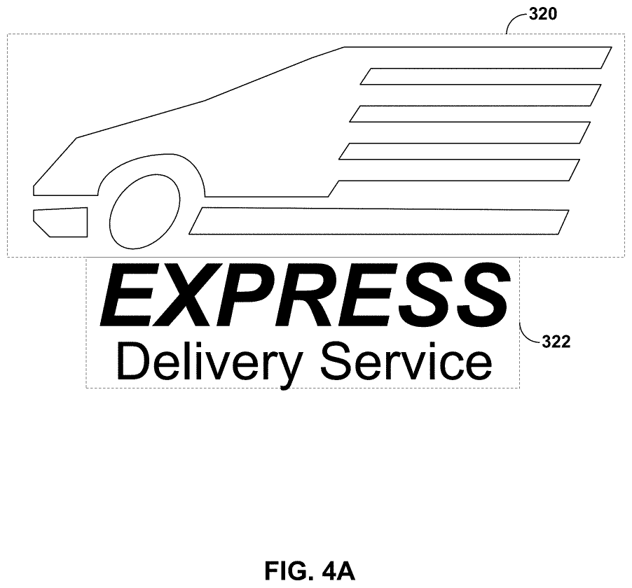

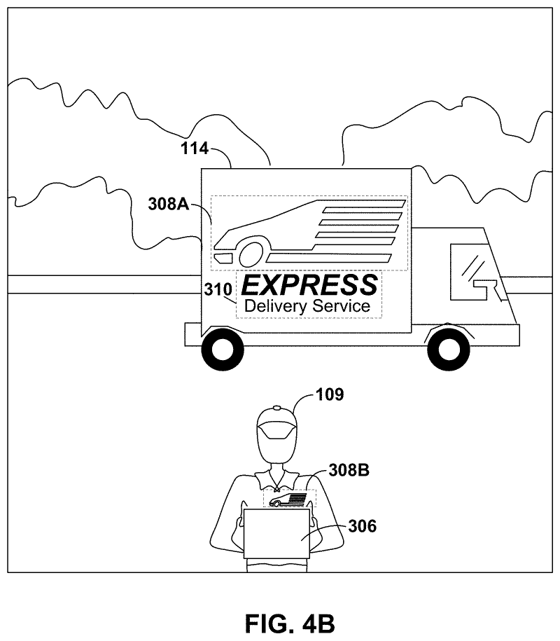

FIGS. 4A and 4B are diagrams illustrating example operation of the security model shown in FIG. 2 in automatically securing the temporary access using machine learning models to validate the third party in accordance with various aspects of the secure temporary access techniques described in this disclosure. In the example of FIG. 4A, the registered logo 320 and registered name 322 are shown again in enlarged form for reference. Security model 232 may obtain image 250A and apply trained models 233, where one or more of trained models 233 are trained using registered images 320 and registered names 322 (possibly multiple different versions of registered images 320 and registered names 322, including multiple images of scenes in which various versions of registered images 320 and/or registered names 322 appear).

As shown in the example of FIG. 4B, trained models 233 may identify logos 308A and 308B and name 310 as described above with respect to FIG. 3C, calculating confidence scores 330 and 332. When confidence scores 330 and 332 exceed a first threshold confidence score (e.g., 70%, 80% or possibly 90% or higher or in some instances lower), security model 232 may validate third party 109 without requiring any manual interaction by second party 105 via second party device 104. In some instances, security model 232 may compare, when confidence scores 330 and/or 332 are below the first threshold confidence score, but above a lower, second threshold confidence score (compared to the first threshold confidence score), security model 232 may enter the assisted image analysis mode described above with respect to the example of FIG. 3C. Security model 232 may, when confidence scores 330 and/or 332 are below the second, lower threshold confidence score, enter the fully manual image based validation mode described above with respect to the examples of FIGS. 3A and/or 3B.

Although various aspects of the assisted and automated image-based validation are described with respect to logos and names, the assisted and/or automated image-based validation may identify and validate based on different aspects of images 250, such as faces, specific arm positions by a third party that the third party may use to validate the third party as authorized to access the locked space 103 of the vehicle 102, the presence of a package or other item, a particular clothing item of a particular color (such as a brown hat), a color, shape, and/or type of delivery vehicle 114, or any other distinct and/or visible aspect of images 250. As such, the techniques should not be limited to logos and/or names, but may apply to any aspect of images to which trained models 233 may be applied in order to validate third party 109.

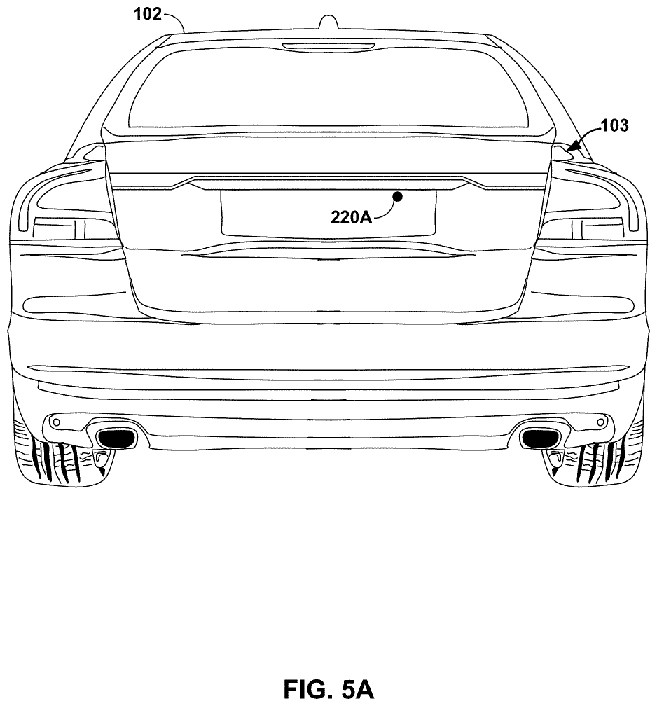

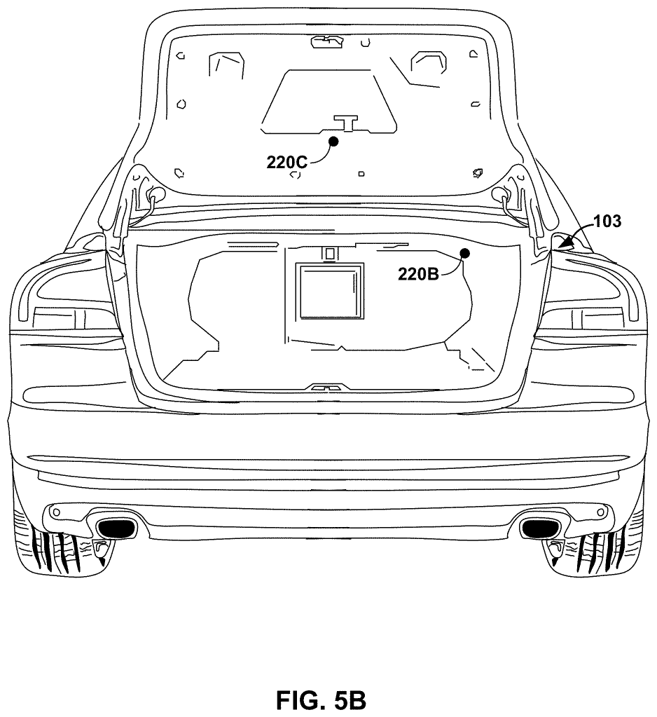

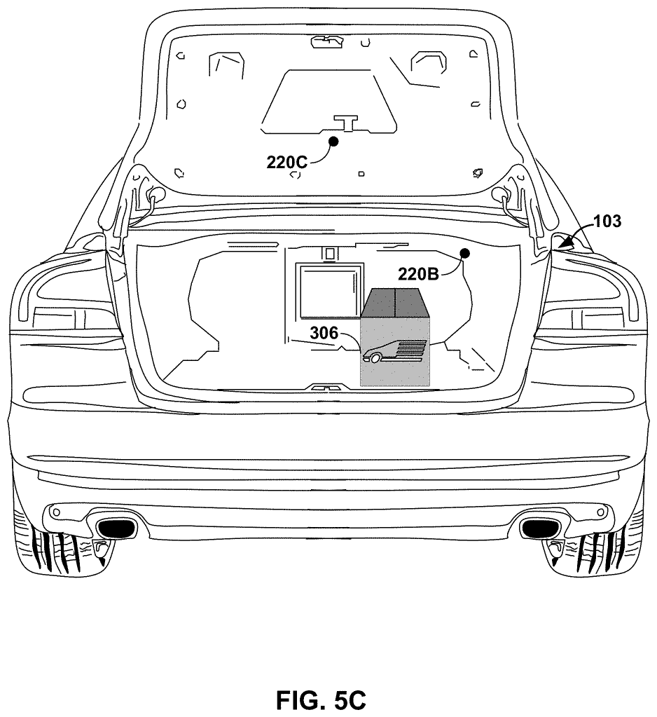

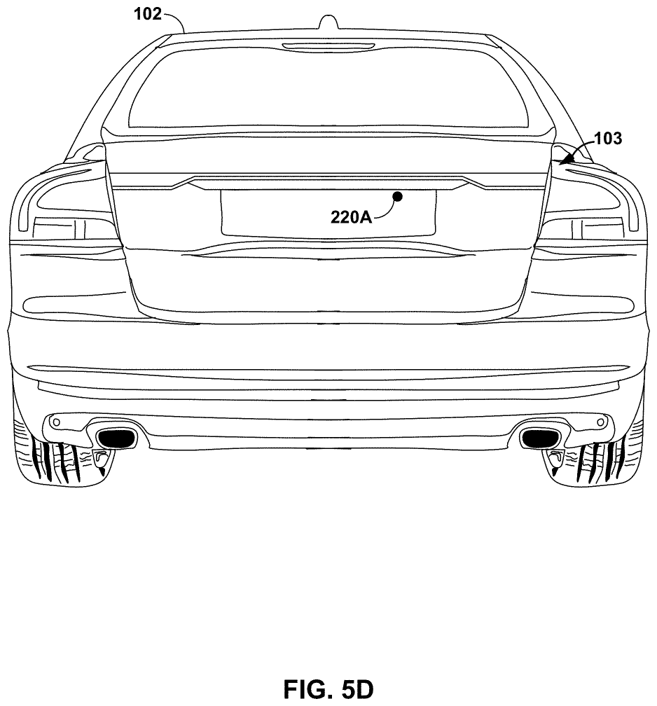

FIGS. 5A-5D are diagrams illustrating a sequence by which the third party may temporarily access a locked trunk of a second party vehicle to deliver a package while monitored in accordance with various aspects of the secure temporary access techniques. As shown in FIG. 5A, remotely operable vehicle 102 includes a camera 220A, which may represent one of cameras 220 shown in the example of FIG. 2, facing behind remotely operable vehicle 102 (which is also referred to as a backup camera 220A). Third party 109 may request access via third party device 108, whereupon third party 109 may be validated as described in more detail above. Control system 202 (which is another way to refer to computing device 202 shown in the example of FIG. 2) may activate camera 220A during validation of third party 109. Assuming successful validation of third party 109, control system 202 (which is another way to refer to computing device 202 shown in the example of FIG. 2) may unlock a locked space 103, which in this example is the trunk and as such the locked space 103 may be referred to as “trunk 103”), and either automatically raises trunk 103 or allows third party 109 to open trunk 103.

After validating third party 109, or after unlocking trunk 103, or possibly in response to detecting that trunk 103 is open, control system 202 may deactivate camera 220A and activate camera 220B and/or 220C shown in the example of FIG. 5B. Control system 202 may also activate one or more interior lights, rear backup lights or other lights (including lights in the trunk, which are not shown in the example of FIG. 5B for ease of illustration purposes) to allow camera 220B and/or 220C to view the delivery of package 306 by third party 109 to trunk 103. Control system 202 may forward images 250 captured by cameras 220B and/or 220C to second party device 104 such that second party may monitor delivery of package 306 to trunk 103 (where the result of such delivery is shown in the example of FIG. 5C).

Referring next to the example of FIG. 5D, control system 202 may continue to provide images 250 captured by cameras 220B and/or 220C to second party device 104 until trunk 103 is closed, whereupon control system 202 may deactivate cameras 220B and/or 220C and activate camera 220A to monitor third party 109 as third party 109 leaves remotely operable vehicle 102. In this respect, second party 105 may monitor delivery of package 306 to trunk 103 by third party 109.

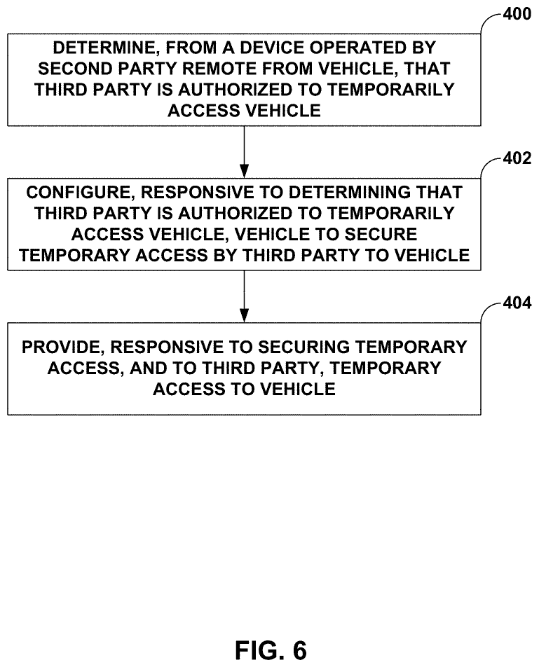

FIG. 6 is a flowchart illustrating example operation of a control system configured to perform various aspects of the secure temporary access techniques described in this disclosure. As described above, control system 202 may determine, from device 104 operated by second party 105, that third party 109 is authorized to temporarily access locked space 103 of vehicle 102 (400). Control system 202 may be configured to, responsive to determining that third party is authorized to temporarily access locked space 103 of vehicle 102, secure the temporary access by third party 109 to locked space 103 of vehicle 102 (402). Control system 202 next may provide, responsive to securing the temporary access, and to third party 109, temporary access to locked space 103 of vehicle 102 (404).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a web site, server, or other remote source using a coaxial cable, fibre optic cable, twisted pair, digital subscriber line (DSL), or wireless technologies such as infrared, radio, and microwave, then the coaxial cable, fibre optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable gate arrays (FPGAs), complex programmable logic devices (CPLDs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

What is claimed is:

1. A method comprising:
determining, by a control system configured to control one or more aspects of a vehicle associated with an authorized operator of the vehicle and from a device operated by the authorized operator remotely from the vehicle, that a third party is authorized to temporarily access at least a portion of the vehicle;
configuring, by the control system and responsive to determining that the third party is authorized to temporarily access at least the portion of the vehicle, the vehicle to secure the temporary access by the third party to at least the portion of the vehicle; and
providing, by the control system, responsive to securing the temporary access, and to the third party, the temporary access to at least the portion of the vehicle.

2. The method of claim 1, wherein configuring the vehicle to secure the temporary access comprises activating one or more cameras to monitor the temporary access by the third party to at least the portion of the vehicle.

3. The method of claim 1, wherein configuring the vehicle to secure the temporary access comprises:
activating one or more cameras to capture an image during the temporary access by the third party to at least the portion of the vehicle; and
transmitting the image to a device associated with the authorized operator.

4. The method of claim 1, wherein configuring the vehicle to secure the temporary access comprises:
activating one or more cameras to capture an image during the temporary access by the third party to at least the portion of the vehicle; and
performing image analysis with respect to the image to validate the third party, and
wherein providing the temporary access comprises providing, responsive to validating the third party, the temporary access to at least the portion of the vehicle.

5. The method of claim 4, wherein performing the image analysis comprises:
performing the image analysis with respect to the image to identify a portion of the image that includes a logo associated with the third party;
comparing the portion of the image to a reference image associated with the logo; and
validating, based on the comparison, the third party.

6. The method of claim 2, wherein the vehicle includes the one or more cameras.

7. A control system configured to control one or more aspects of a vehicle associated with an authorized operator, the control system comprising:
at least one processor; and
a memory comprising instructions that, when executed by the at least one processor, cause the at least one processor to:
determine, from a device operated by the authorized operator remotely from the vehicle, that a third party is authorized to temporarily access at least a portion of the vehicle;
configure, responsive to determining that the third party is authorized to temporarily access at least the portion of the vehicle, the vehicle to secure the temporary access by the third party to at least the portion of the vehicle; and
provide, responsive to securing the temporary access, and to the third party, the temporary access to at least the portion of the vehicle.

8. The control system of claim 7, wherein the at least one processor is configured to activate one or more cameras to monitor the temporary access by the third party to at least the portion of the vehicle.

9. The control system of claim 7, wherein the at least one processor is configured to:
activate one or more cameras to capture an image during the temporary access by the third party to at least the portion of the vehicle; and
transmit the image to a device associated with the authorized operator.

10. The control system of claim 7, wherein the at least one processor is configured to:
activate one or more cameras to capture an image during the temporary access by the third party to at least the portion of the vehicle; and
perform image analysis with respect to the image to validate the third party, and
provide, responsive to validating the third party, the temporary access to at least the portion of the vehicle.

11. The control system of claim 10, wherein the at least one processor is configured to:
perform the image analysis with respect to the image to identify a portion of the image that includes a logo associated with the third party;
compare the portion of the image to a reference image associated with the logo; and
validate, based on the comparison, the third party.

12. The control system of claim 11, wherein the vehicle includes the one or more cameras.

13. The control system of claim 11, wherein the one or more cameras include a backup camera configured to capture images directed to a rear of the vehicle.

14. The control system of claim 7, wherein the at least one processor is further configured to:
receive, after providing the temporary access, a command originated by the third party to unlock at least the portion of the vehicle; and
unlock, in response to the command, at least the portion of the vehicle.

15. The control system of claim 7, wherein the at least one processor is further configured to:
receive, after providing the temporary access, a command originated by the third party to unlock at least the portion of the vehicle;
unlock at least the portion of the vehicle;
determine that at least the portion of the vehicle that is unlocked has been opened and then closed;
lock, responsive to determining that at least the portion of the vehicle has been opened and closed, at least the portion of the vehicle.

16. The control system of claim 15, wherein the at least one processor is configured to unlock only a specific portion of the vehicle.

17. The control system of claim 15, wherein the at least one processor is configured to lock, responsive to determining that at least the portion of the vehicle has been opened and closed, only the at least the portion of the vehicle.

18. The control system of claim 7, wherein at least the portion of the vehicle comprises one or more of a hood, a glove compartment access panel, a door, a trunk, a boot, and a fuel delivery access panel.

19. The control system of claim 7, wherein the at least one processor is configured to determine, from the device operated by the authorized operator via an intermediate system to which the vehicle is communicatively coupled, that the third party is authorized to temporarily access at least the portion of the vehicle.

20. A computer-readable storage medium comprising instructions that, when executed by at least one processor of a control system configured to control one or more aspects of a vehicle associated with an authorized operator, cause the at least one processor to:
determine, from a device operated by the authorized operator remotely from the vehicle, that a third party is authorized to temporarily access at least a portion of the vehicle;
configure, responsive to determining that the third party is authorized to temporarily access at least the portion of the vehicle, the vehicle to secure the temporary access by the third party to at least the portion of the vehicle; and
provide, responsive to securing the temporary access, and to the third party, the temporary access to at least the portion of the vehicle.
